(19) United States
(12) Patent Application Publication
(10) Pub. No.: US 2013/0340231 A1
(43) Pub. Date: Dec. 26, 2013

(54) Filter Assembly and Method for Assembling the Same

(71) Applicant: Wix Filtration Corp LLC, Gastonia, NC (US)

(72) Inventor: Chun Lu, Shanghai (CN)

(21) Appl. No.: 13/927,188

(22) Filed: Jun. 26, 2013

Related U.S. Application Data
(60) Provisional application No. 61/664,592, filed on Jun. 26, 2012.

(51) Int. Cl. B01D 35/30

(52) U.S. Cl. CPC B01D 35/30
USPC 29/428; 210/541

(57) ABSTRACT

A sub-assembly of a filter assembly is disclosed. The sub-assembly includes an endcap having a substantially cylindrical sidewall including an exterior surface and an interior surface and a housing having a substantially cylindrical sidewall including an exterior surface and an interior surface. The exterior surface forms at least one exterior recessed region. A portion of a length of the substantially cylindrical sidewall of the housing is deformed such that a portion of the interior surface of the substantially cylindrical sidewall of the housing is arranged at least partially within the at least one exterior recessed region formed by the exterior surface of the substantially cylindrical sidewall of the endcap for mechanically-coupling the housing to the endcap. A method is also disclosed.

### FIELD

The invention relates to filters.

### BACKGROUND

Various filters are known in the art for filtering fluid as it passes through a fluid path. Filters include, in part, filter media which removes impurities from a fluid, such as, for example, oil or fuel that passes through filter media.

In most applications, either a filter assembly or the filter media associated therewith must be periodically replaced to reduce the potential of developing unacceptably high impedance in the fluid path flow restriction.

While known filters have proven to be acceptable for various applications, such conventional filters are nevertheless susceptible to improvements that may enhance their overall performance and cost. Therefore, a need exists to develop improved filters and methodologies for forming the same that advance the art.

### BRIEF DESCRIPTION OF THE DRAWINGS

The present disclosure will now be described, by way of example, with reference to the accompanying drawings, in which:

FIG. 1 is a view of a filter assembly in accordance with an exemplary embodiment of the invention.

FIG. 2 is a cross-sectional view of the filter assembly according to line 2-2 of FIG. 1.

FIG. 3 is an exploded view of the filer assembly of FIG. 1.

FIG. 4 is a view of a filter element of the filter assembly of FIG. 1 in accordance with an exemplary embodiment of the invention.

FIGS. 5A-5C are views of an endcap of the filter assembly of FIG. 1 in accordance with an exemplary embodiment of the invention.

FIG. 6 is a view of a housing of the filter assembly of FIG. 1 in accordance with an exemplary embodiment of the invention.

FIG. 7 is a view of a fluid-directing fin of the filter assembly of FIG. 1 in accordance with an exemplary embodiment of the invention.

FIG. 8 is a view of another endcap of the filter assembly of FIG. 1 in accordance with an exemplary embodiment of the invention.

FIGS. 9A-9D are views of a filter assembly and a device for joining a housing of the filter device to an endcap of the filter assembly in accordance with an exemplary embodiment of the invention.

FIGS. 10A, 10B and 10C are cross-sectional views according to line 10-10 of FIG. 9C in accordance with an exemplary embodiment of the invention.

FIGS. 11A-11C illustrate a filter assembly and a device for joining a housing of the filter device to an endcap of the filter assembly in accordance with an exemplary embodiment of the invention.

FIG. 12A is a cross-sectional view according to line 12A-12A of FIG. 11A.

FIG. 12B is a cross-sectional view according to line 12B-12B of FIG. 11B.

FIG. 12C is a cross-sectional view according to line 12C-12C of FIG. 11C.

FIGS. 13A-13C illustrate a filter assembly and a device for joining a housing of the filter device to an endcap of the filter assembly in accordance with an exemplary embodiment of the invention.

FIGS. 14A-14C illustrate a filter assembly and a device for joining a housing of the filter device to an endcap of the filter assembly in accordance with an exemplary embodiment of the invention.

FIGS. 15A-15C illustrate a filter assembly and a device for joining a housing of the filter device to an endcap of the filter assembly in accordance with an exemplary embodiment of the invention.

FIGS. 16A-16C illustrate a forming device and blank of material for forming a housing of a filter assembly in accordance with an exemplary embodiment of the invention.

FIGS. 17A-17B illustrate a forming device and blank of material for forming a housing of a filter assembly in accordance with an exemplary embodiment of the invention.

FIGS. 18A-18C illustrate a forming device and blank of material for forming a housing of a filter assembly in accordance with an exemplary embodiment of the invention.

FIGS. 19A-19C are views of a filter assembly in accordance with an exemplary embodiment of the invention.

FIG. 20A is a cross-sectional view according to line 20A-20A of FIG. 19B.

FIG. 20B is another cross-sectional view according to FIG. 20A.

FIG. 20C is a cross-sectional view according to line 20C-20C of FIG. 19C in accordance with an exemplary embodiment of the invention.

### DETAILED DESCRIPTION

The Figures illustrate exemplary embodiments of a filter assembly and methods for assembling the same in accordance with embodiments of the invention, and, based on the foregoing, it is to be generally understood that the nomenclature used herein is simply for convenience and the terms used to describe the invention should be given the broadest meaning by one of ordinary skill in the art.

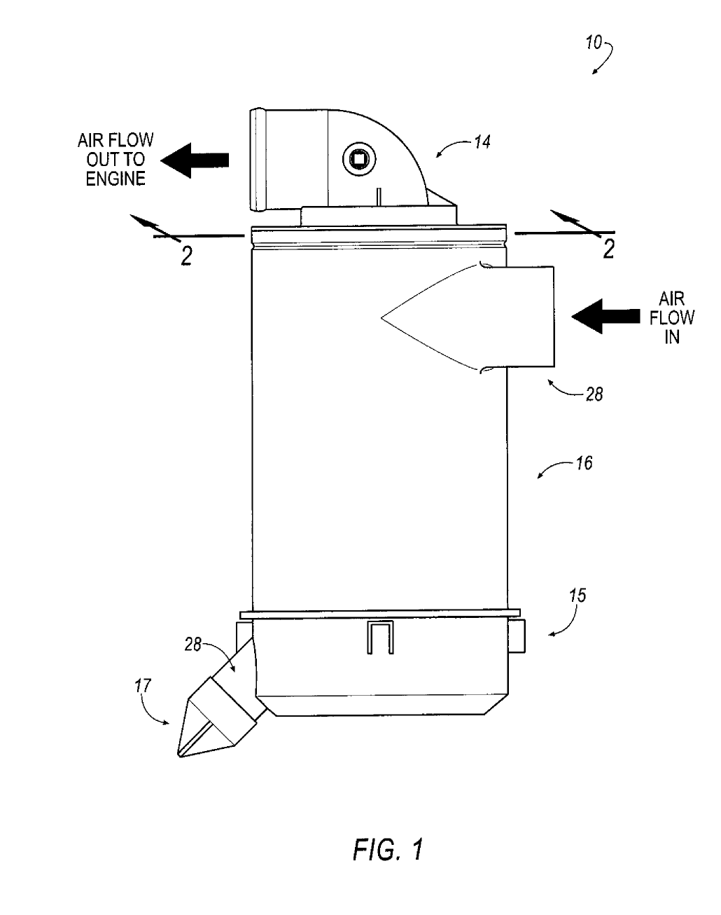

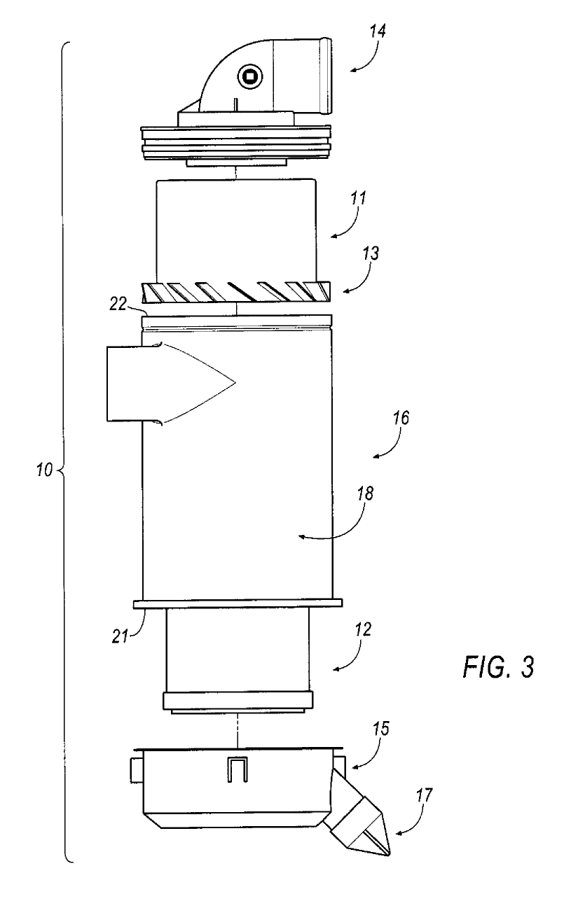

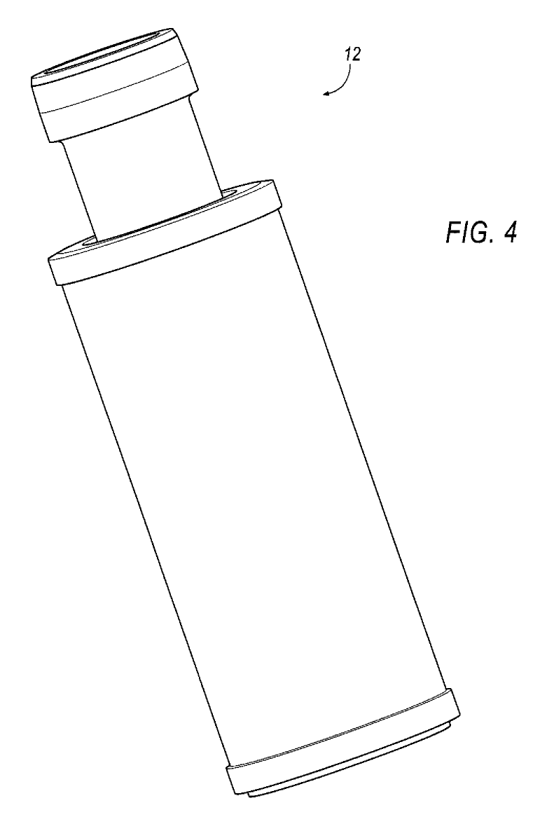

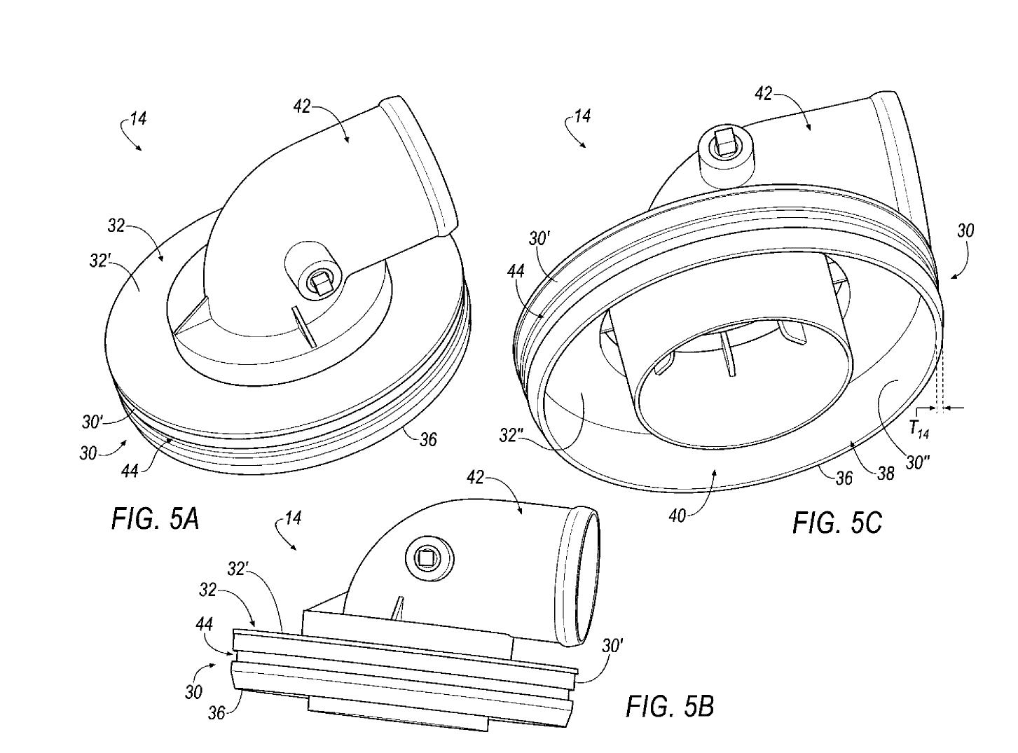

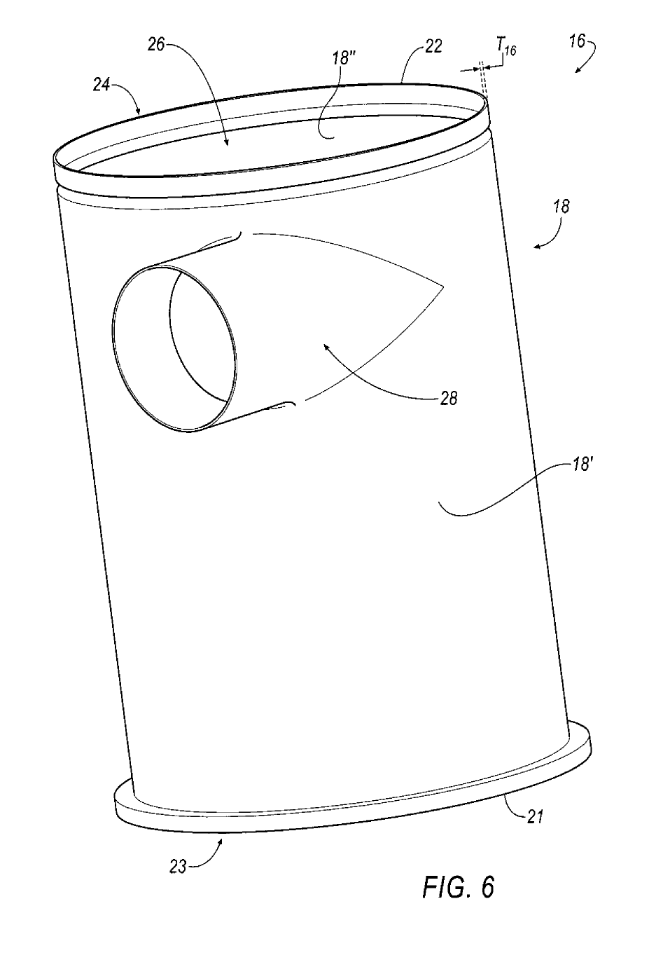

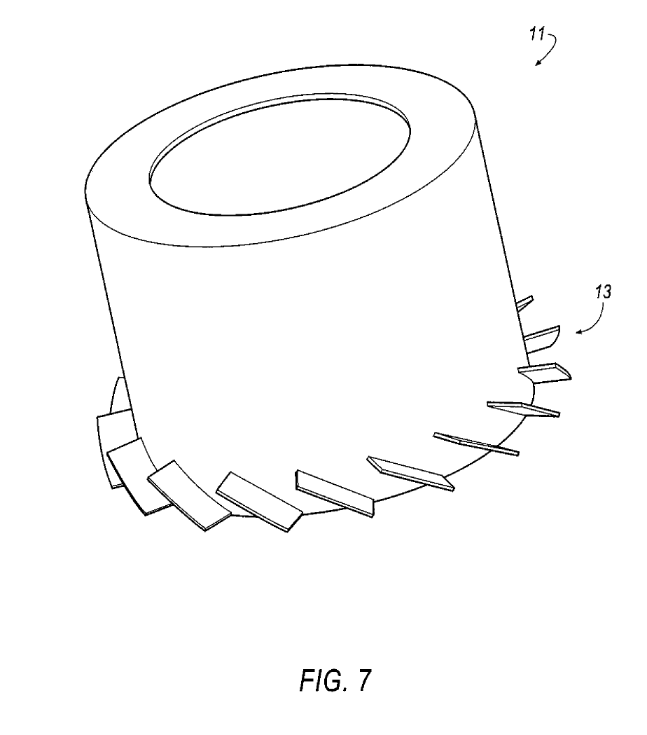

Referring to FIGS. 1-3, a filter assembly is shown generally at 10 in accordance with an exemplary embodiment of the invention. The filter assembly 10 includes at least: a filter element 12 (see also, e.g., FIG. 4), an endcap 14 (see also, e.g., FIGS. 5A-5C) and a housing 16 (see also, e.g., FIG. 6). The filter assembly 10 may also include a fluid-directing member 11 (see also FIG. 7) including fluid-directing fins 13 and another endcap member 15 (see also, e.g., FIG. 8) including a removable dust collector cap member 17.

The endcap 14 and housing 16 may be made from any desirable material. In some implementations, the endcap 14 may be made from a first material, and, the housing 16 may be made from a second material that is different from the first material; in some implementations, the first material may include any desirable plastic, and, the second material may include any desirable metal.

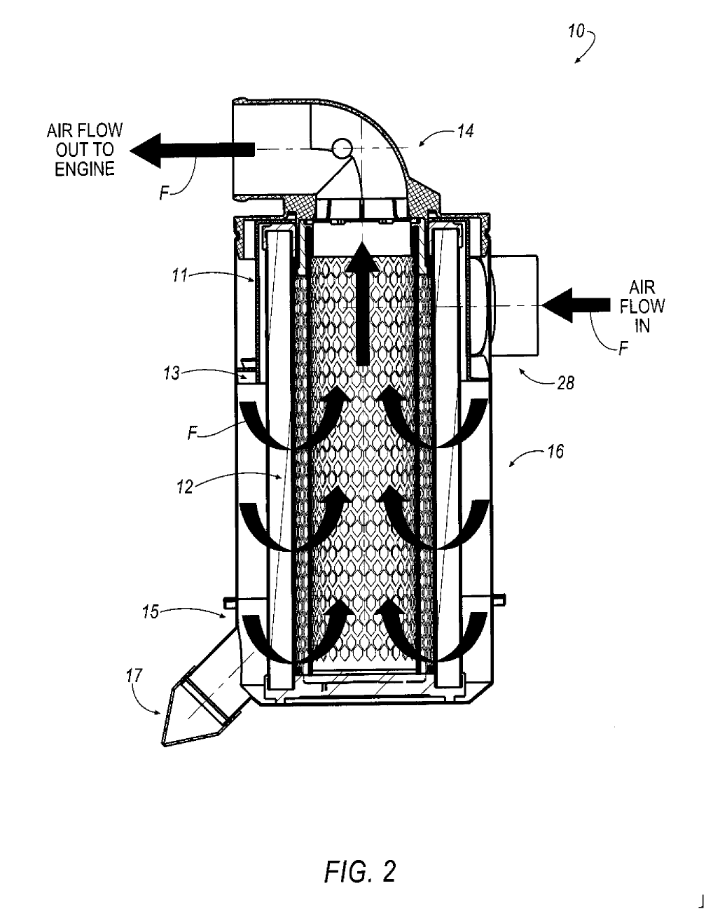

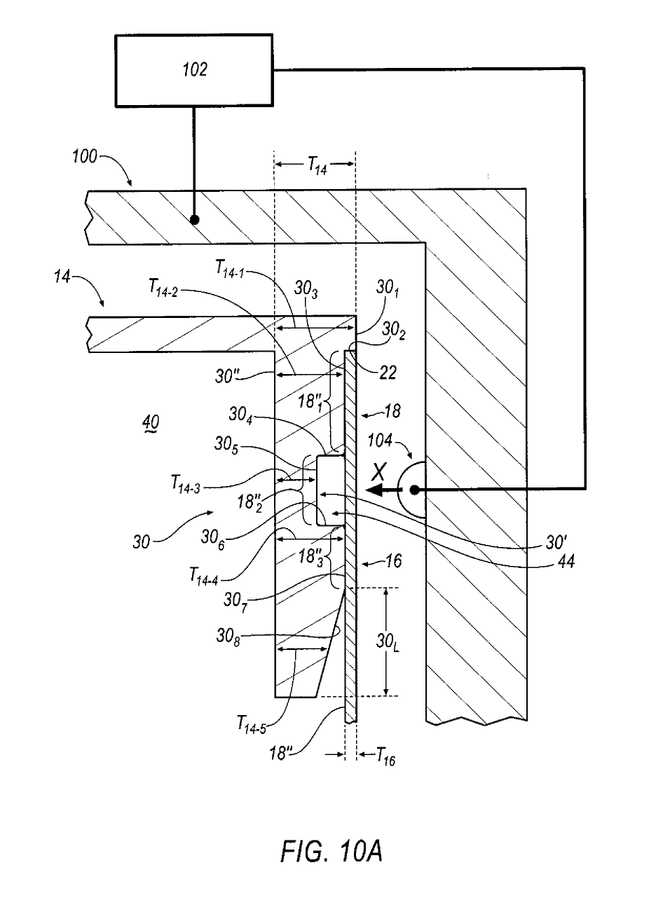

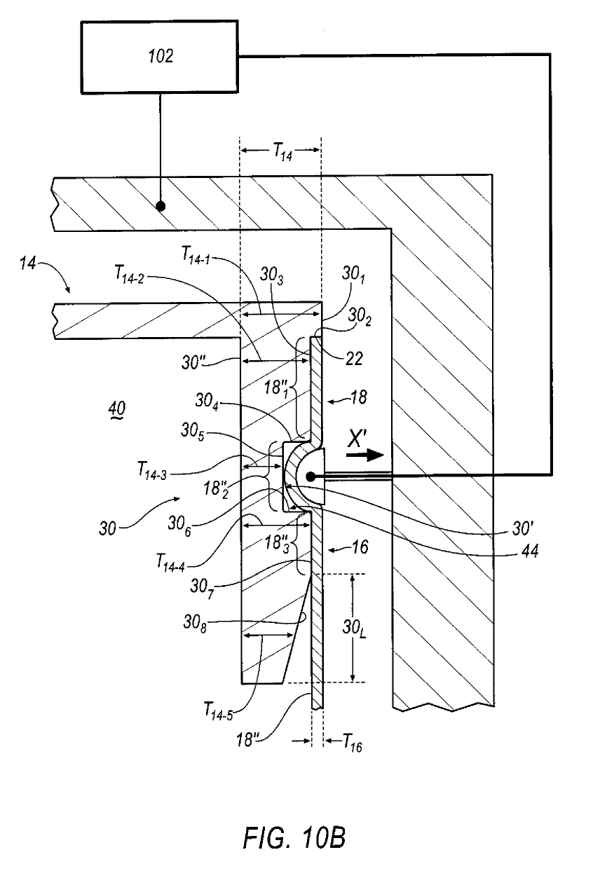

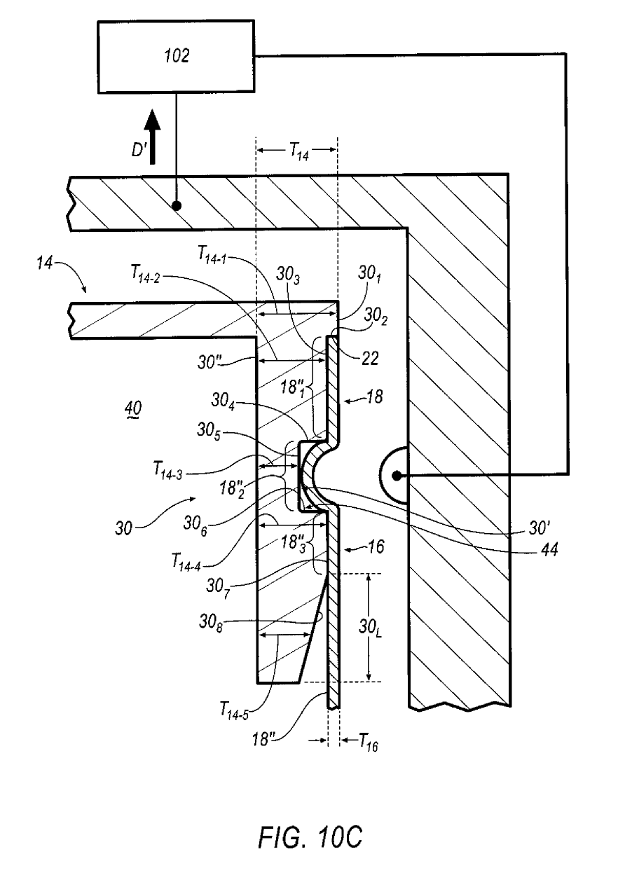

Referring to FIG. 6, the housing 16 may be shaped to include a substantially cylindrical sidewall 18 having a thickness, T₁₆ (see also, e.g., FIGS. 10A, 10B, 10C). The endcap member 15 may be connected to a proximal end 21 the substantially cylindrical sidewall 18 of the housing 16 for closing-out a proximal opening 23 of the housing 16. The substantially cylindrical sidewall 18 may also include a distal end 22 that forms a substantially circular distal opening 24. The substantially circular distal opening 24 permits access to a cavity 26 formed at least partially by an interior surface 18″ of the substantially cylindrical sidewall 18 and an interior surface 15′ (see, e.g., FIG. 8) of the endcap member 15 including the removable dust collector cap member 17. One or more fluid flow ports 28 may extend from an exterior surface 18′ of the substantially cylindrical sidewall 18 in order to permit flow of a fluid, F (see, e.g., FIG. 2) into the cavity 26; impurities (e.g., dust) may be filtered from the fluid, F, (by the filter media 12) that flows out of the cavity 26 and into dust collector cap member 17, which may be removably-coupled to the endcap member 15.

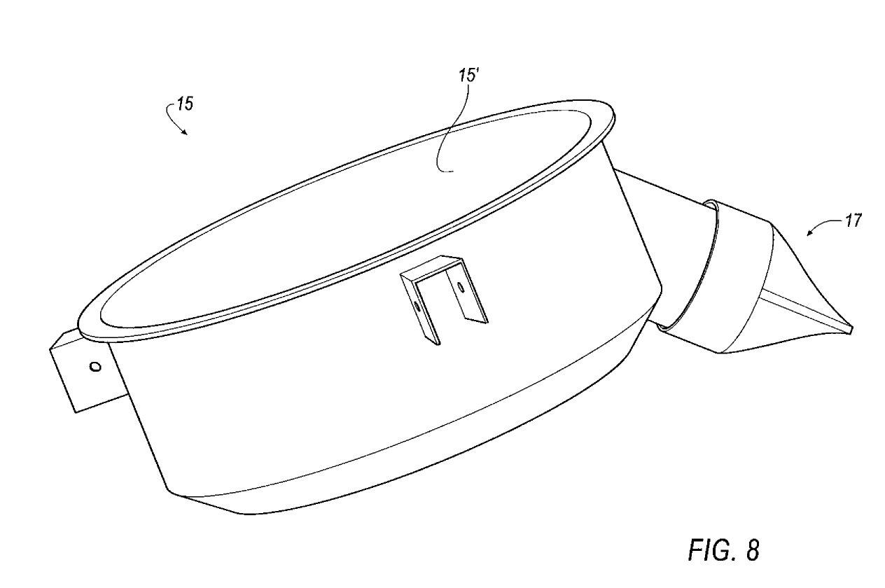

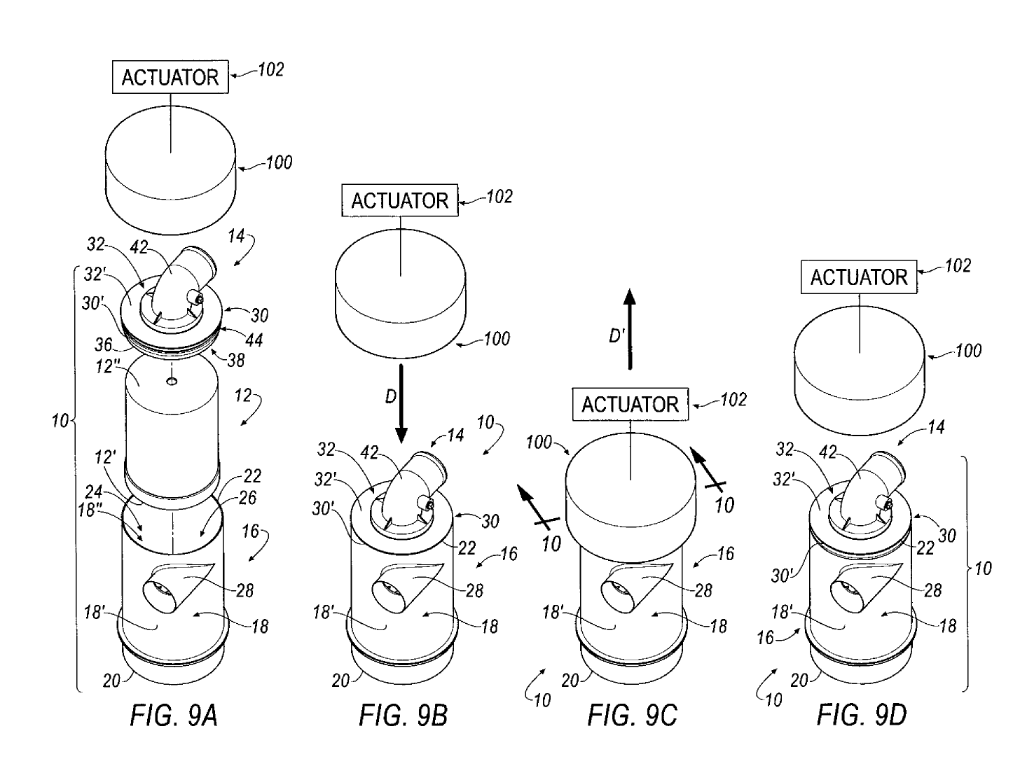

With reference to FIG. 9A, the filter media 12 may include at least a substantially cylindrical body of fluid filtration material that filters the fluid, F, that is directed into the cavity 26. When arranged within the cavity 26, the filter media may include a first end 12′ arranged near the proximal end 21 of the substantially cylindrical sidewall 18 of the housing 16 near the endcap member 15 and a second end 12″ arranged at least proximate the distal end 22 of the substantially cylindrical sidewall 18 of the housing 16. One the filter media 12 is arranged within the cavity 26, the endcap 14 may be attached to the distal end 22 of the substantially cylindrical sidewall 18 of the housing 16.

Referring to FIGS. 5A-5C, the endcap 14 may be shaped to include a substantially cylindrical sidewall 30 having a thickness, T₁₄ (see also, e.g., FIGS. 10A, 10B, 10C). The endcap 14 may further include a substantially enclosed end 32 having an exterior surface 32′ and an interior surface 32″ that is connected to the substantially cylindrical sidewall 30. The substantially cylindrical sidewall 30 may include a distal end 36 that forms an opening 38. The opening 38 permits access to a cavity 40 (see also, e.g., FIGS. 10A, 10B, 10C) formed by the substantially cylindrical sidewall 30 and the interior surface 32′ of the substantially enclosed end 32. One or more fluid flow ports 42 may extend from an exterior surface 32′ of the substantially enclosed end 32 in order to permit flow of the fluid, F (that was previously directed into the cavity 26, through filter media 12), out of the cavity 40.

Referring to FIGS. 9A-9D and 10A-10C, a method for assembling the filter assembly 10 is described according to an embodiment. Referring to FIGS. 9A-9B, the components of the filter assembly 10 are connected together and arranged proximate an assembling device 100. The assembling device 100 may be connected to an actuator 102. The actuator 102 may cause movement according to the direction of the arrow, D (as seen in, e.g., FIG. 9B), toward the filter assembly 10. Once arranged in an aligned orientation with respect to the filter assembly 10, the assembling device 100 may conduct work upon the filter assembly 10 in order to join or mechanically couple two or more components of the filter assembly 10 together. Once work on the filter assembly 10 is completed, the actuator 102 may cause movement of the device 100 away from the filter assembly 10 according to the direction of the arrow, D′ (see, e.g., FIG. 9C), which is opposite the direction of the arrow, D.

Reference is made to FIGS. 10A-10C where a thickness, T₁₄, of the endcap 14 is described according to an embodiment. The thickness, T₁₄, of the endcap 14 may include a plurality of different thicknesses along the length of the substantially cylindrical sidewall 30 of the endcap 14. For example, as seen in FIGS. 10A, 10B, 10C, the thickness, T₁₄, of the endcap 14 may include, but is not limited to, five different thicknesses along the length of the substantially cylindrical sidewall 30 that are generally identified at T₁₄₋₁, T₁₄₋₂, T₁₄₋₃, T₁₄₋₄, T₁₄₋₅. The first thickness, T₁₄₋₁, may be referred to as a maximum thickness. The second thickness, T₁₄₋₂, may be substantially equal to but slightly less than the first, maximum thickness, T₁₄₋₁. The third thickness, T₁₄₋₃, may be less than the second thickness, T₁₄₋₂, that is substantially equal to but slightly less than the first, maximum thickness, T₁₄₋₁. The fourth thickness, T₁₄₋₄, may be substantially equal to the second thickness, T₁₄₋₂. The fifth thickness, T₁₄₋₅, may include a non-constant thickness along a portion of the length 30_{L} of the substantially cylindrical sidewall 30 whereas the first, second, third and fourth thicknesses, T₁₄₋₁, T₁₄₋₂, T₁₄₋₃, T₁₄₋₄, are constant along their respective portions of lengths of the substantially cylindrical sidewall 30.

With continued reference to FIGS. 10A, 10B, 10C, the substantially cylindrical sidewall 30 of the endcap 14 may include a plurality of exterior sidewall surface portions that are generally identified at 30₁, 30₂, 30₃, 30₄, 30₅, 30₆, 30₇, 30₈. In an implementation, the interior surface 30″ of the substantially cylindrical sidewall 30 and the first exterior sidewall surface portion 30₁ may form the first thickness, T₁₄₋₁, of the substantially cylindrical sidewall 30. In an implementation, the interior surface 30″ of the substantially cylindrical sidewall 30 and the third exterior sidewall surface portion 30₃ may form the second thickness, T₁₄₋₂, of the substantially cylindrical sidewall 30. In an implementation, the second exterior sidewall surface portion 30₂ may be substantially perpendicular to both of the first exterior sidewall surface portion 30₁ and the third exterior sidewall surface portion 30₃ and demarcates the first thickness, T₁₄₋₁, of the substantially cylindrical sidewall 30 from the second thickness, T₁₄₋₂, of the substantially cylindrical sidewall 30.

In an implementation, the interior surface 30″ of the substantially cylindrical sidewall 30 and the fifth exterior sidewall surface portion 30₅ may form the third thickness, T₁₄₋₃, of the substantially cylindrical sidewall 30. In an implementation, the fourth exterior sidewall surface portion 30₄ may be substantially perpendicular to both of the third exterior sidewall surface portion 30₃ and the fifth exterior sidewall surface portion 30₅ and demarcates the second thickness, T₁₄₋₂, of the substantially cylindrical sidewall 30 from the third thickness, T₁₄₋₃, of the substantially cylindrical sidewall 30.

In an implementation, the interior surface 30″ of the substantially cylindrical sidewall 30 and the seventh exterior sidewall surface portion 30₇ may form the fourth thickness, T₁₄₋₄, of the substantially cylindrical sidewall 30. In an implementation, the sixth exterior sidewall surface portion 30₆ may be substantially perpendicular to both of the fifth exterior sidewall surface portion 30₅ and the seventh exterior sidewall surface portion 30₇ and demarcates the third thickness, T₁₄₋₃, of the substantially cylindrical sidewall 30 from the fourth thickness, T₁₄₋₄, of the substantially cylindrical sidewall 30.

in an implementation, the interior surface 30″ of the substantially cylindrical sidewall 30 and the eighth exterior sidewall surface portion 30₈ may form the fifth thickness, T₁₄₋₅, of the substantially cylindrical sidewall 30. In an implementation, the seventh exterior sidewall surface portion 30₇ is directly connected to the eighth exterior sidewall surface portion 30₈; the connection of the seventh exterior sidewall surface portion 30₇ to the eighth exterior sidewall surface portion 30₈ demarcates the fourth thickness, T₁₄₋₄, of the substantially cylindrical sidewall 30 from the fifth thickness, T₁₄₋₅.

The fourth, fifth and sixth exterior sidewall surface portions 30₄, 30₅, 30₆ collectively form at least one exterior recessed region 44 (see, also, e.g., FIGS. 5A-5C and 9A) in an exterior surface 30′ of the substantially cylindrical sidewall 30 of the endcap 14 (noting that the exterior surface 30′ of the substantially cylindrical sidewall 30 of the endcap 14 is opposite from the interior surface 30″ of the substantially cylindrical sidewall 30 of the endcap 14 forming the cavity 40 of the endcap 14. In some implementations, as seen in, for example, FIGS. 5B and 9A, the at least one recessed region 44 may circumscribe the entire circumference of the exterior surface 30′ of the substantially cylindrical sidewall 30 of the endcap 14. In other implementations, the at least one recessed region 44 may include a plurality (not shown) of interrupted recessed regions 44 that are arranged in a circular pattern so as to circumscribe a region of a circumference of the exterior surface 30′ of the substantially cylindrical sidewall 30 of the endcap 14 in a substantially similar manner and region of the exemplary illustrated embodiment of FIGS. 5B and 9A.

Referring to FIGS. 9A-9B, once the filter media 12 is arranged within the cavity 26 of the housing 16, and, the endcap 14 is disposed upon the housing 16 (thereby fluidly-sealing and closing-out the opening 24 of the housing 16), the endcap 14 may be spatially arranged adjacent the housing 16 according to the following embodiment. Referring to FIG. 10A, firstly, the distal end 22 of the substantially cylindrical sidewall 18 of the housing 16 may be arranged adjacent the second exterior sidewall surface portion 30₂ of the substantially cylindrical sidewall 30 of the endcap 14, and, secondly, a first portion 18″₁ and a third portion 18″₃ of the interior surface 18″ the substantially cylindrical sidewall 18 of the housing 16 may be arranged adjacent the third exterior sidewall surface portion 30₃ and the seventh exterior sidewall surface portion 30₇ of the substantially cylindrical sidewall 30 of the endcap 14. A second portion 18″₂ of the interior surface 18″ the substantially cylindrical sidewall 18 of the housing 16 is located between the first portion 18″₁ and the third portion 18″₃ of the interior surface 18″ the substantially cylindrical sidewall 18 of the housing 16 and is initially arranged in communication with the at least one exterior recessed region 44 of the substantially cylindrical sidewall 30 of the endcap 14, and, the second portion 18″₂ of the interior surface 18″ the substantially cylindrical sidewall 18 is initially not arranged adjacent any of the exterior sidewall surface portions 30₁-30₈ of the endcap 14.

Referring to FIGS. 9B-9C, a device 100 for shaping/deforming the housing 16 may be arranged proximate the arrangement of the filter media 12, the endcap 14 and housing 16 as shown and described above in FIG. 10A. In an implementation, an actuator 102 connected to the device 100 may cause movement, according to direction of arrow, D (see, e.g., FIG. 9B), toward the filter media 12, the endcap 14 and housing 16.

In an implementation, as seen in FIG. 10A, after ceasing movement according to the direction of arrow, D, the device 100 may be arranged proximate the housing 16 in a manner so as to align a deforming portion 104 (e.g., a movable punching device, a moveable or stationary mandrel or the like) with the at least one exterior recessed region 44 of the substantially cylindrical sidewall 30 of the endcap 14. The actuator 102 may be communicatively-coupled to the deforming portion 104 in order to cause movement according to the direction of the arrow, X, of the deforming portion 104 from a retracted orientation (see, e.g., FIG. 10A) to a deployed position (see, e.g., FIG. 10B). When arranged in the deployed position, the deforming portion 104 will materially deform or shape the substantially cylindrical sidewall 18 of the housing 16 in order to cause movement of the second portion 18″₂ of the interior surface 18″ the substantially cylindrical sidewall 18 of the housing 16 from a first position (as seen in, e.g., FIG. 10A) that is not within the at least one exterior recessed region 44 of the substantially cylindrical sidewall 30 of the endcap 14 to a second position (as seen in, e.g., FIG. 10B) within the at least one exterior recessed region 44 of the substantially cylindrical sidewall 30 of the endcap 14. In an implementation, when the second portion 18″₂ of the interior surface 18″ the substantially cylindrical sidewall 18 of the housing 16 is arranged in the second position, at least a portion of the second portion 18″₂ of the interior surface 18″ the substantially cylindrical sidewall 18 of the housing 16 may be arranged adjacent one or more of the fourth, fifth and sixth exterior sidewalk surface portions 30₄, 30₅, 30₆, of the endcap 14 that forms the at least one exterior recessed region 44 of the substantially cylindrical sidewall 30 of the endcap 14.

After materially deforming or shaping the substantially cylindrical sidewall 18 of the housing 16 as described above in FIG. 10B, the housing 16 may said to be mechanically-coupled to the endcap 14, thereby locking the filter media 12 within the cavities 26, 40 of the housing 16 and endcap 14. Once the housing 16 is mechanically-coupled to the endcap 14, the actuator 102 may cause movement of the deforming device 104 from the deployed position back to the retracted position according to the direction of the arrow, X′ (see, e.g., FIG. 10B), which is opposite the direction of the arrow, X. Then, as seen in FIGS. 9C and 10C, the actuator 102 may cause movement of the device 100 away from the filter assembly 10 according to the direction of the arrow, D′, which is opposite the direction of the arrow, D.

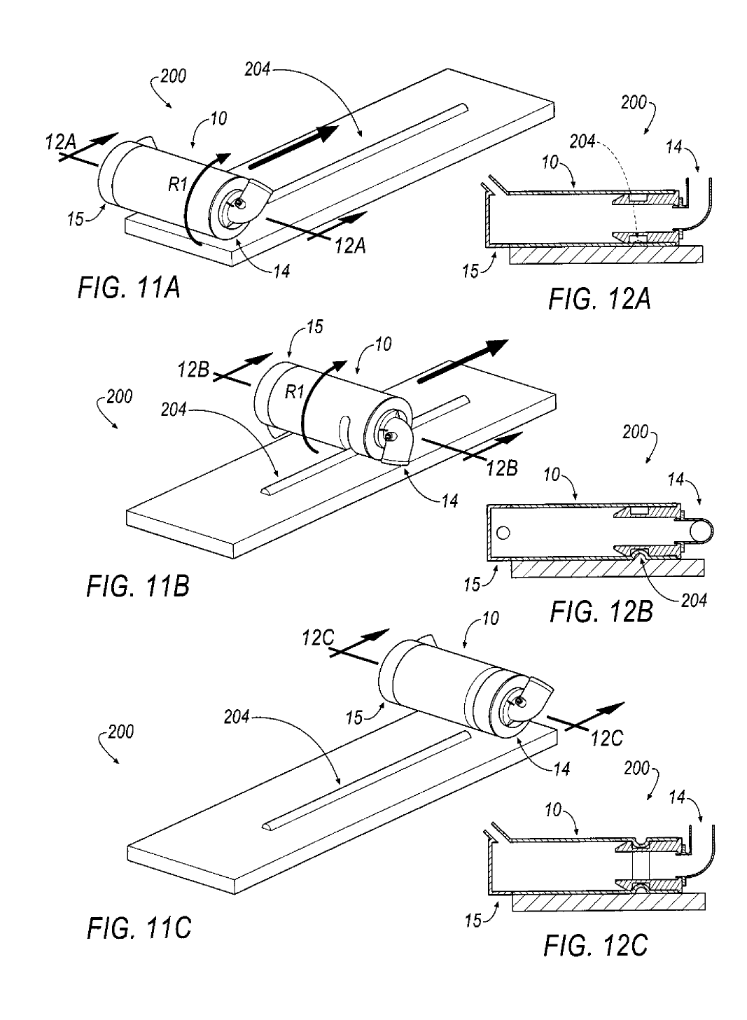

Although the housing 16 may be mechanically-coupled to the endcap 14 as described above, other methodologies may be utilized for deforming or shaping the substantially cylindrical sidewall 18 of the housing 16 in order to arrange the second portion 18″₂ of the interior surface 18″ the substantially cylindrical sidewall 18 of the housing 16 in the second position such that at least a portion of the second portion 18″₂ of the interior surface 18″ the substantially cylindrical sidewall 18 of the housing 16 may be arranged adjacent one or more of the fourth, fifth and sixth exterior sidewall surface portions 30₄, 30₅, 30₆, of the endcap 14 that forms the at least one exterior recessed region 44 of the substantially cylindrical sidewall 30 of the endcap 14. For example, as seen in FIGS. 11A-11C and 12A-12C, a device 200 including a mandrel 204 is shown according to an embodiment. The mandrel 204 may include an elongated bead of rigid material. In an embodiment, the filter media 12, endcap 14 and housing 16 may be arranged in a manner so as to align the at least one exterior recessed region 44 of the substantially cylindrical sidewall 30 of the endcap 14 with the mandrel 204. The filter media 12, endcap 14 and housing 16 may then be moved (e.g., rolled, R1, or roll-over, R1) the mandrel 204 in order to deform or shape the substantially cylindrical sidewall 18 of the housing 16 in order to arrange the second portion 18″₂ of the interior surface 18″ the substantially cylindrical sidewall 18 of the housing 16 in the second position (as seen in, e.g., FIG. 12B) such that at least a portion of the second portion 18″₂ of the interior surface 18″ the substantially cylindrical sidewall 18 of the housing 16 may be arranged adjacent one or more of the fourth, fifth and sixth exterior sidewall surface portions 30₄, 30₅, 30₆, of the endcap 14 that forms the at least one exterior recessed region 44 of the substantially cylindrical sidewall 30 of the endcap 14.

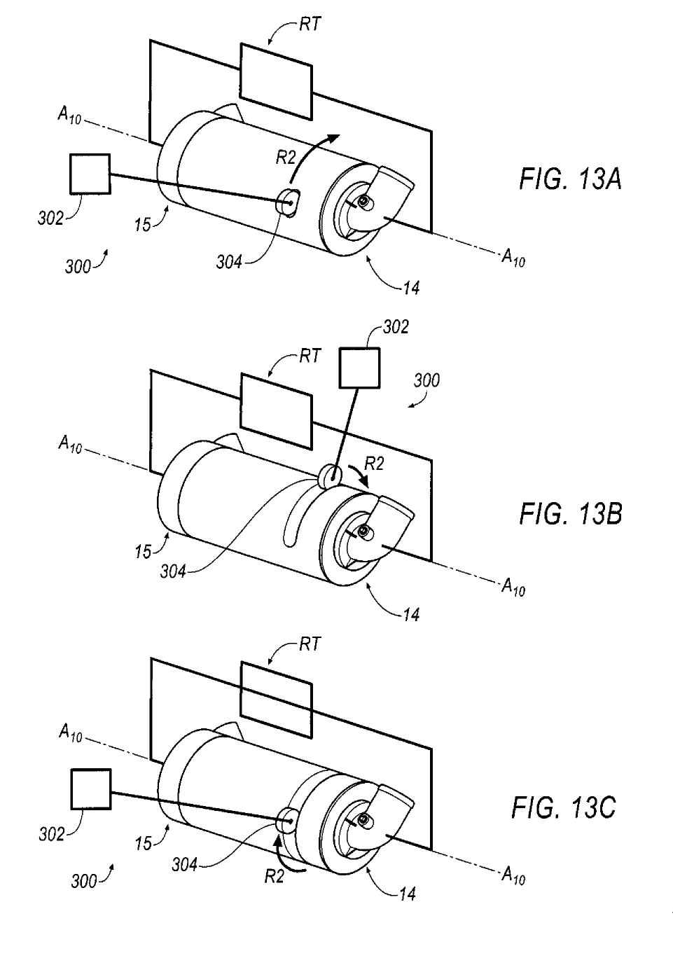

In another example, as seen in FIGS. 13A-13C, a device 300 including a mandrel 304 is shown according to an embodiment. The mandrel 304 may include, but is not limited to, for example, a wheel of rigid material. In an embodiment, the filter media 12, endcap 14 and housing 16 may be arranged in a manner so as to align the at least one exterior recessed region 44 of the substantially cylindrical sidewall 30 of the endcap 14 with the mandrel 304. The filter media 12, endcap 14 and housing 16 may be retained by a retainer, RT, in a spatially-fixed orientation about an axis, A₁₀-A₁₀, while the mandrel 304 is arranged in direct contact with the housing 16 and moved (e.g., rolled, R2, or roll-over, R2) the housing 16 in order to deform or shape the substantially cylindrical sidewall 18 of the housing 16 in order to arrange the second portion 18″₂ of the interior surface 18″ the substantially cylindrical sidewall 18 of the housing 16 in the second position such that at least a portion of the second portion 18″₂ of the interior surface 18″ the substantially cylindrical sidewall 18 of the housing 16 may be arranged adjacent one or more of the fourth, fifth and sixth exterior sidewall surface portions 30₄, 30₅, 30₆, of the endcap 14 that forms the at least one exterior recessed region 44 of the substantially cylindrical sidewall 30 of the endcap 14. The mandrel 304 may be connected to an actuator 302 that causes movement of the mandrel 304 relative to the housing 16.

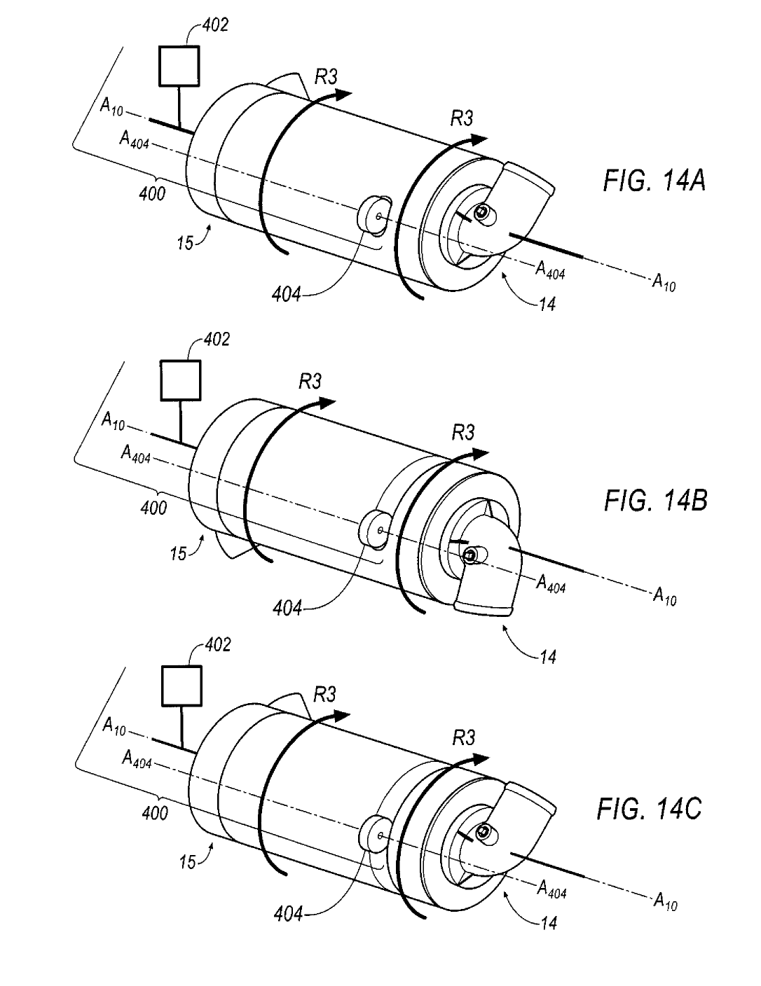

In another example, as seen in FIGS. 14A-14C, a device 400 including a mandrel 404 is shown according to an embodiment. The mandrel 404 may include, but is not limited to, for example, a wheel of rigid material. In an embodiment, the filter media 12, endcap 14 and housing 16 may be arranged in a manner so as to align the at least one exterior recessed region 44 of the substantially cylindrical sidewall 30 of the endcap 14 with the mandrel 404. The filter media 12, endcap 14 and housing 16 may be connected to an actuator 402 such that the actuator 402 may cause rotation of the filter media, endcap 14, and housing 16 about an axis, A₁₀-A₁₀, while the mandrel 404 is arranged in contact with the housing 16 a spatially-fixed orientation about an axis, A₄₀₄-A₄₀₄, in order to deform or shape the substantially cylindrical sidewall 18 of the housing 16 in order to arrange the second portion 18″₂ of the interior surface 18″ the substantially cylindrical sidewall 18 of the housing 16 in the second position such that at least a portion of the second portion 18″₂ of the interior surface 18″ the substantially cylindrical sidewall 18 of the housing 16 may be arranged adjacent one or more of the fourth, fifth and sixth exterior sidewall surface portions 30₄, 30₅, 30₆, of the endcap 14 that forms the at least one exterior recessed region 44 of the substantially cylindrical sidewall 30 of the endcap 14.

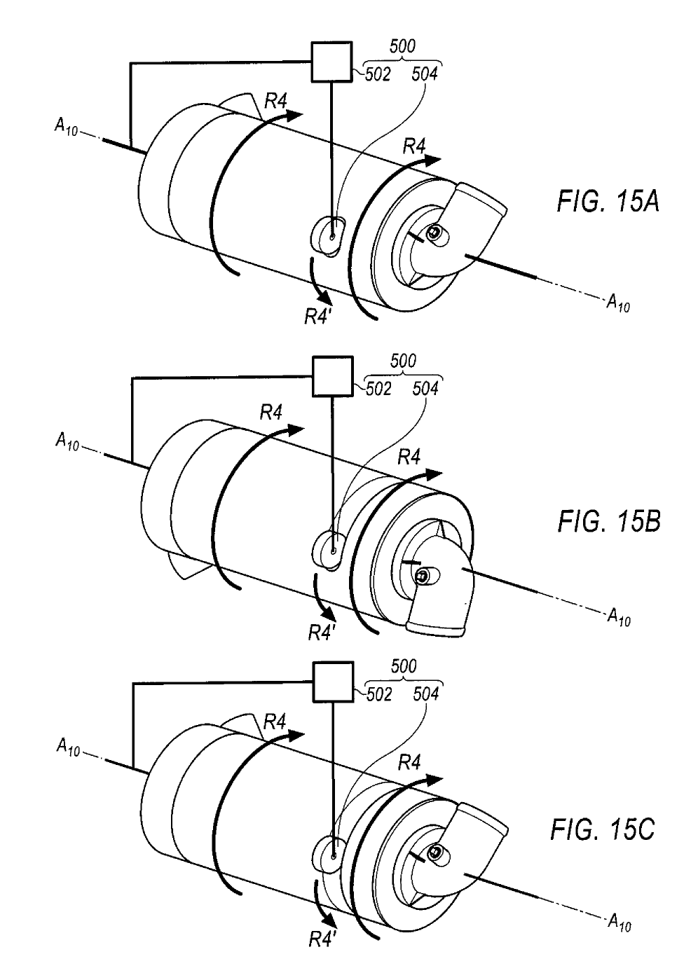

In another example, as seen in FIGS. 15A-15C, a device 500 including a mandrel 504 is shown according to an embodiment. The mandrel 504 may include, but is not limited to, for example, a wheel of rigid material. In an embodiment, the filter media 12, endcap 14 and housing 16 may be arranged in a manner so as to align the at least one exterior recessed region 44 of the substantially cylindrical sidewall 30 of the endcap 14 with the mandrel 504. Each of the mandrel 504 and the filter media 12, endcap 14 and housing 16 may be connected to the actuator 502 such that the actuator 502 may cause rotation of both of the mandrel 502 about an axis, A₁₀-A₁₀, and in contact with the housing 16 while the filter media, endcap 14, and housing 16 are also rotated about the axis, A₁₀-A₁₀, in order to deform or shape the substantially cylindrical sidewall 18 of the housing 16 in order to arrange the second portion 18″₂ of the interior surface 18″ the substantially cylindrical sidewall 18 of the housing 16 in the second position such that at least a portion of the second portion 18″₂ of the interior surface 18″ the substantially cylindrical sidewall 18 of the housing 16 may be arranged adjacent one or more of the fourth, fifth and sixth exterior sidewall surface portions 30₄, 30₅, 30₆, of the endcap 14 that forms the at least one exterior recessed region 44 of the substantially cylindrical sidewall 30 of the endcap 14. In some implementations, the mandrel 504 and the filter media 12, endcap 14 and housing 16 may be both rotated in a similar direction at different speeds. In other implementations, the mandrel 504 and the filter media 12, endcap 14 and housing 16 may be both rotated in opposite R4/R4′ directions.

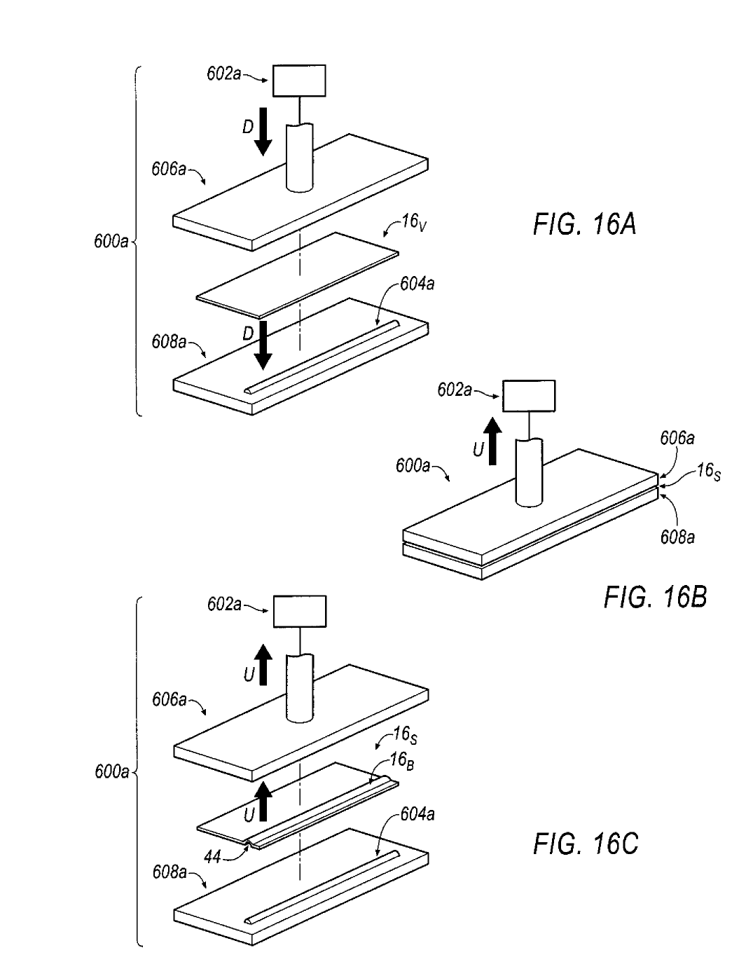

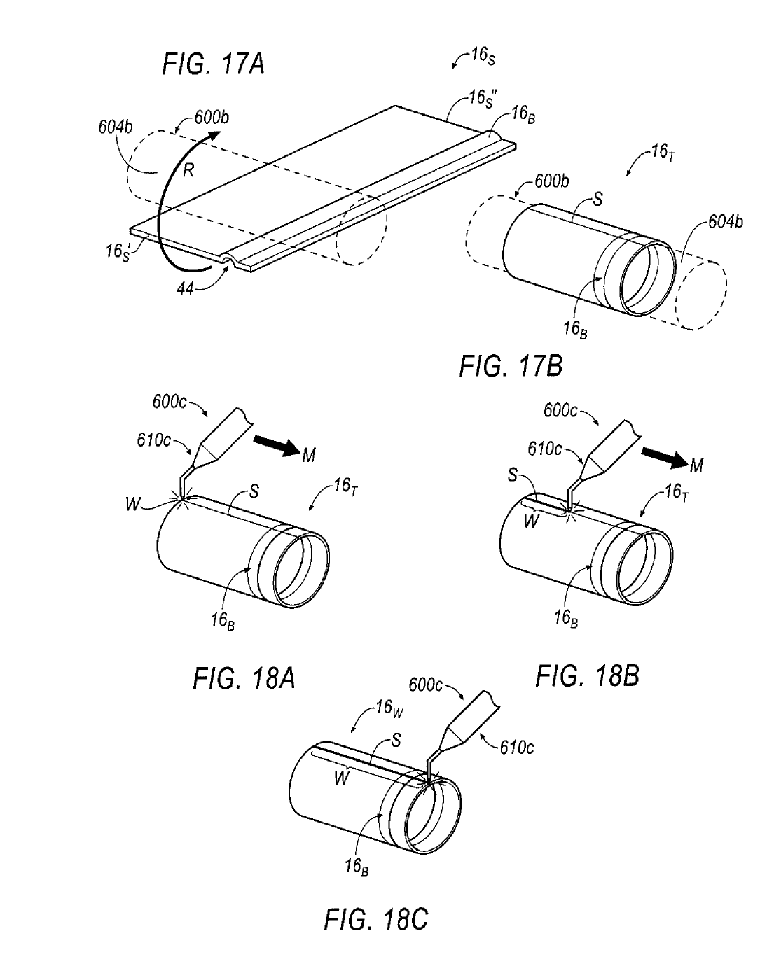

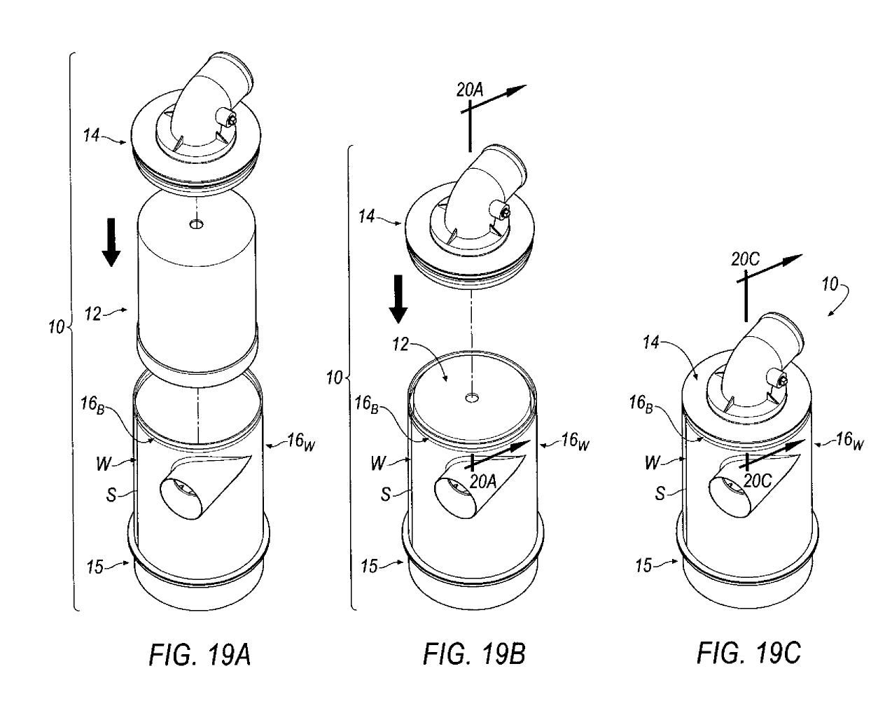

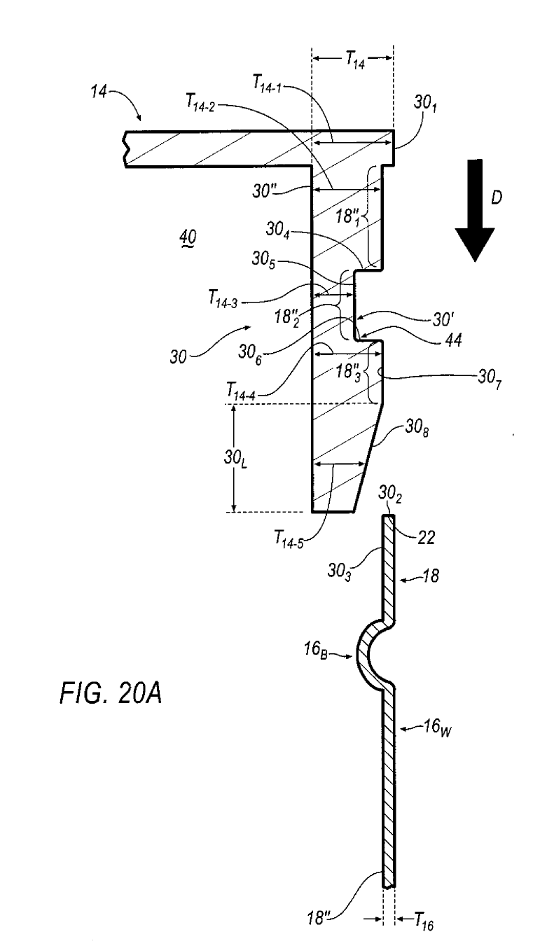

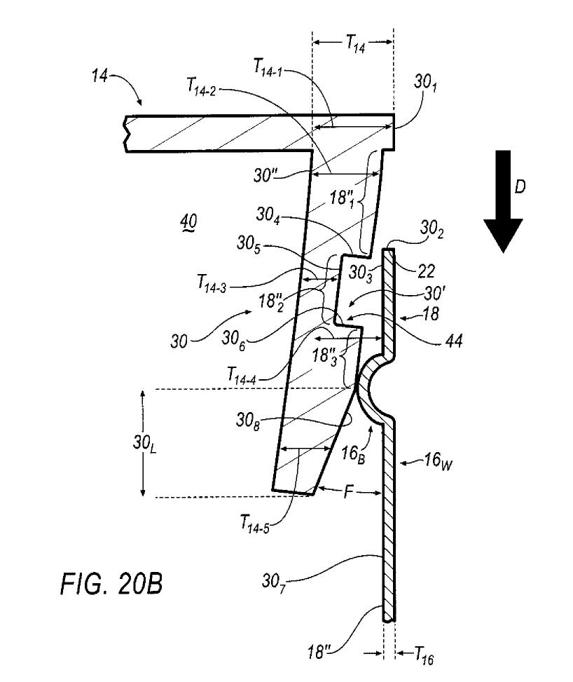

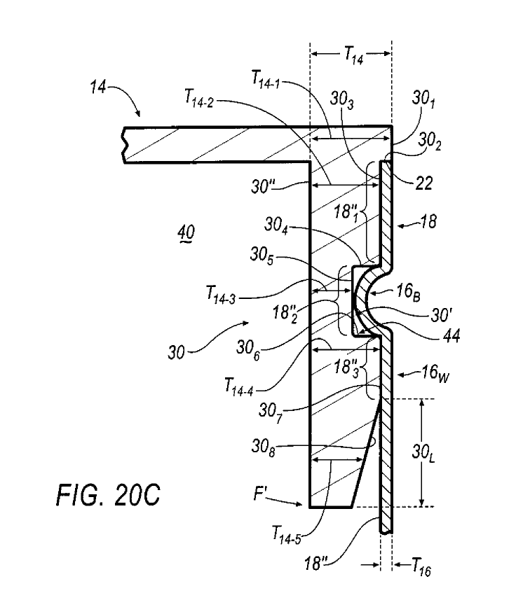

In another example, as seen in FIGS. 16A-16C, a device 600a including a mandrel 604a is shown according to an embodiment. The mandrel 604a may include an elongated bead of rigid material. In an embodiment, the mandrel 604a may be utilized for deforming a portion of a length of a blank of virgin material 16_{V}; the deformed blank of virgin material 16_{V} may be subsequently rolled (see, e.g., FIGS. 17A-17B) then welded (see, e.g., FIGS. 18A-18C) for forming a housing 16 of a filter assembly 10 (see, e.g., FIGS. 19A-20C).

The device 600a may further include an actuator 602a connected to a press comprising a first I upper portion 606a and a second I lower portion 608a. One of the first/upper portion 606a and the second/lower portion 608a may include the mandrel 604a. In some implementations, the first/upper portion 606a may be moveably arranged (see, e.g., down arrow, D, and up arrow, U) relative to a fixed orientation of the second/lower portion 608a. In some implementations, the second/lower portion 608a may include the mandrel 604a.

Referring to FIG. 16A, the press may be arranged in an open orientation, and, the virgin blank material 16_{V} may be arranged between the first/upper portion 606a and the second/lower portion 608a. The actuator 602a, which may be connected to the first/upper portion 606a may cause downward movement, D, toward the virgin blank material 16_{V} and the second/lower portion 608a. The first/upper portion 606a may directly contact and deform the virgin blank material 16_{V} such that the mandrel 604a may materially deform and shape a portion of a length of a blank of virgin material 16_{V} about the mandrel 604a (thereby forming an inwardly-projecting bead 16_{B} as seen in, for example, FIG. 16C). Then, as seen in FIG. 16B, the actuator 602a may subsequently cause upward movement, U, of the first/upper portion 606a away from the second/lower portion 608a. Then, as seen in FIG. 16C, upon shaping the blank of virgin material 16_{V} about the mandrel 604a to include the inwardly-projecting bead 16_{B}, the blank may be referred to as a shaped or stamped blank of material 16_{S}.

In another example, as seen in FIGS. 17A-1B, a device 600b including a mandrel 604b is shown according to an embodiment. The mandrel 604b may include a substantially tubular member of rigid material. In an embodiment, the mandrel 604b may be utilized for deforming the stamped blank of material 16_{S} of FIG. 16C. The stamped blank of material 16_{S} is deformed in a manner by wrapping or rolling, R (FIG. 17A), the stamped blank of material 16_{S} about the mandrel 604b such that the stamped blank of material 16_{S} is formed into a substantially tubular member 16_{T} (see FIG. 17B). When the stamped blank of material 16_{S} is formed into a substantially tubular member 16_{T} as seen in FIG. 17B, opposing ends 16_{S}′, 16_{S}″(see FIG. 17A) of the stamped blank of material 16_{S} are arranged adjacent one another thereby forming a seam, S.

In another example, as seen in FIGS. 18A-18C, a device 600c including a welding apparatus 610c is shown according to an embodiment. The welding apparatus 610c is arranged proximate the seam, S, and, upon actuating the welding apparatus 610c, the seam, S, is welded shut (i.e., the opposing ends 16_{S}′, 16_{S}″ are joined together) thereby forming a welded seam, W. Referring to FIG. 18C, upon welding the entire length of the seam, S, the substantially tubular member 16_{T} may be referred to as a welded substantially tubular member 16_{W}.

Referring to FIG. 19A, the welded substantially tubular member 16_{W} may be utilized as a housing component of a filter assembly 10. As seen in FIG. 19A, the endcap member 15 may be joined to the welded substantially tubular member 16_{W}. Then, as seen in FIG. 19B, the filter element 12 may be arranged within the welded substantially tubular member 16_{W}. Then, as seen in FIG. 19C, the endcap 14 may be joined to the welded substantially tubular member 16_{W} for sealingly-enclosing the filter element 12 within the welded substantially tubular member 16_{W}.

Referring to FIG. 20, in an embodiment, the endcap 14 may be made from a flexible (e.g. plastic) material, and, the welded substantially tubular member 16_{W} may be made from a rigid (e.g., metal) material. Referring to FIG. 0B, as the endcap 14 is joined to the welded substantially tubular member 16_{W}, the portion of the length of the blank of virgin material 16_{V} deformed about the mandrel 604a that may define an inwardly-projecting bead 16_{B} may interfere with movement of the endcap 14 according to the direction of the arrow, D; as a result of the interference, the endcap 14 may flex inwardly according to the direction of the arrow, F. Then, as seen in FIG. 20C, once the at least one recessed region 44 of the exterior surface 30′ of the substantially cylindrical sidewall 30 of the endcap 14 is aligned with the inwardly-projecting bead 16_{B}, the endcap 14 snaps/flexes outwardly according to the direction of the arrow, F′, which is opposite the direction of the arrow, F, for mechanically joining the endcap 14 to the welded substantially tubular member 16_{W}, thereby forming the filter assembly 10.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A sub-assembly of a filter assembly, comprising:
an endcap having a substantially cylindrical sidewall including an exterior surface and an interior surface, wherein the exterior surface forms at least one exterior recessed region; and
a housing having a substantially cylindrical sidewall including an exterior surface and an interior surface, wherein a portion of a length of the substantially cylindrical sidewall of the housing is deformed such that a portion of the interior surface of the substantially cylindrical sidewall of the housing is arranged at least partially within the at least one exterior recessed region formed by the exterior surface of the substantially cylindrical sidewall of the endcap for mechanically-coupling the housing to the endcap.

2. The sub-assembly according to claim 1, wherein the substantially cylindrical sidewall including a thickness, wherein the thickness includes a plurality of different thicknesses along a length of the substantially cylindrical sidewall including at least, for example, a first thickness, a second thickness, a third thickness, a fourth thickness, and a fifth thickness.

3. The sub-assembly according to claim 2, wherein the second thickness is substantially equal to but slightly less than the first thickness, wherein the third thickness is less than the second thickness, wherein the fourth thickness is substantially equal to the second thickness.

4. The sub-assembly according to claim 2, wherein the fifth thickness is a non-constant thickness along a portion of the length of the substantially cylindrical sidewall of the endcap whereas the first, second, third and fourth thicknesses are each substantially constant along a remainder of the length of the substantially cylindrical sidewall of the endcap.

5. The sub-assembly according to claim 2, wherein the substantially cylindrical sidewall of the endcap may include a plurality of exterior sidewall surface portions including a first exterior sidewall surface portion, a second exterior sidewall surface portion, a third exterior sidewall surface portion, a fourth exterior sidewall surface portion, a fifth exterior sidewall surface portion, a sixth exterior sidewall surface portion, a seventh exterior sidewall surface portion, and an eighth exterior sidewall surface portion.

6. The sub-assembly according to claim 5, wherein the interior surface of the substantially cylindrical sidewall of the endcap and the first exterior sidewall surface portion forms the first thickness, wherein the interior surface of the substantially cylindrical sidewall of the endcap and the third exterior sidewall surface portion forms the second thickness, wherein the interior surface of the substantially cylindrical sidewall of the endcap and the fifth exterior sidewall surface portion forms the third thickness, wherein the interior surface of the substantially cylindrical sidewall of the endcap and the seventh exterior sidewall surface portion forms the fourth thickness, wherein the interior surface of the substantially cylindrical sidewall and the eighth exterior sidewall surface portion forms the fifth thickness.

7. The sub-assembly according to claim 6, wherein the second exterior sidewall surface portion is substantially perpendicular to both of the first exterior sidewall surface portion and the third exterior sidewall surface portion and demarcates the first thickness from the second thickness, wherein the fourth exterior sidewall surface portion is substantially perpendicular to both of the third exterior sidewall surface portion and the fifth exterior sidewall surface portion and demarcates the second thickness from the third thickness, wherein the sixth exterior sidewall surface portion is substantially perpendicular to both of the fifth exterior sidewall surface portion and the seventh exterior sidewall surface portion and demarcates the third thickness from the fourth thickness, wherein the seventh exterior sidewall surface portion is directly connected to the eighth exterior sidewall surface portion, wherein the connection of the seventh exterior sidewall surface portion to the eighth exterior sidewall surface portion demarcates the fourth thickness from the fifth thickness.

8. The sub-assembly according to claim 7, wherein the fourth, fifth and sixth exterior sidewall surface portions collectively form the at least one exterior recessed region.

9. The sub-assembly according to claim 1, wherein the at least one recessed region circumscribes an entire circumference of the exterior surface of the substantially cylindrical sidewall of the endcap.

10. A method for assembling a filter assembly, comprising the steps of:
providing an endcap including a substantially cylindrical sidewall including an exterior surface and an interior surface, wherein the exterior surface forms at least one exterior recessed region;
providing a housing including a substantially cylindrical sidewall including an exterior surface and an interior surface;
arranging the exterior surface of substantially cylindrical sidewall of the endcap substantially adjacent the interior surface of the substantially cylindrical sidewall of the housing;
deforming a portion of a length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap for
mechanically-coupling the housing to the endcap.

11. The method according to claim 10, wherein the deforming step includes
utilizing a punch for punching the portion of the length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap.

12. The method according to claim 10, wherein the deforming step includes
rolling the housing and the endcap across a mandrel for indenting the portion of the length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap.

13. The method according to claim 10, wherein the deforming step includes
retaining the housing and the endcap in an axially-fixed orientation about an axis while
rotating an indenting roller about the housing for indenting the portion of the length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap.

14. The method according to claim 10, wherein the deforming step includes
retaining an indenting roller in an axially-fixed orientation while
rotating the housing and the endcap about an axis for indenting the portion of the length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap.

15. The method according to claim 10, wherein the deforming step includes
rotating the housing and the endcap about an axis in a first direction and rotating an indenting roller about the axis in a second direction that is opposite the first direction for
indenting the portion of the length of the substantially cylindrical sidewall of the housing such that a portion of the interior surface of the substantially cylindrical sidewall of the housing is arranged at least partially within the at least one exterior recessed region formed by the exterior surface of the substantially cylindrical sidewall of the endcap.

16. A method for assembling a filter assembly, comprising the steps of:
providing a housing including a substantially cylindrical sidewall including an exterior surface and an interior surface, wherein the housing is formed from a blank of material by:
deforming the blank of material in order to form an inwardly-projecting bead along a portion of a length of the blank of material,
shaping the blank of material from a first, substantially planar geometry to a second, substantially tubular geometry such that opposing ends of the blank of material are arranged adjacent one another thereby forming a seam along a length of the blank of material, and
joining the opposing ends of the blank of material;
providing an endcap including a substantially cylindrical sidewall including an exterior surface and an interior surface, wherein the exterior surface forms at least one exterior recessed region; and
arranging the exterior surface of substantially cylindrical sidewall of the endcap substantially adjacent the interior surface of the substantially cylindrical sidewall of the housing such that the inwardly-projecting bead along a portion of a length of the blank of material of the housing is registered within the at least one exterior recessed region of the endcap for
mechanically-coupling the housing to the endcap.

17. The method according to claim 16, wherein the deforming step includes:
stamping the blank of material with a press.

18. The method according to claim 16, wherein the shaping step includes:
rolling the blank of material over a mandrel.

19. The method according to claim 16, wherein the shaping step includes:
welding the blank of material with the welding device.

20. The method according to claim 16, wherein prior to mechanically-coupling the housing to the endcap, further comprising the steps of:
connecting a second endcap to the housing thereby forming a filter-media-receiving-cavity; and
arranging filter media within the filter-media-receiving-cavity.
